(19) United States
(12) Patent Application Publication
(10) Pub. No.: US 2003/0092865 A1
(43) Pub. Date: May 15, 2003

(54) Silicone based ultraviolet absorbing and/or scattering compounds and associated formulations comprising the same

(76) Inventor: Michael E. Silver, Grandville, MI (US)

Correspondence Address: FACTOR & PARTNERS, PLC, 305 HOOVER BOULEVARD, SUITE 300, HOLLAND, MI, 49423, US

(21) Appl. No.: 10/254,431

(22) Filed: Sep. 25, 2002

Related U.S. Application Data
(60) Provisional application No. 60/324,570, filed on Sep. 25, 2001.
(60) Provisional application No. 60/344,659, filed on Dec. 24, 2001.
(60) Provisional application No. 60/351,952, filed on Jan. 25, 2002.
(60) Provisional application No. 60/387,618, filed on Jun. 11, 2002.

(51) Int. Cl. C08G 77/04

(52) U.S. Cl. 528/26

(57) ABSTRACT

A compound represented by the following structural formula:

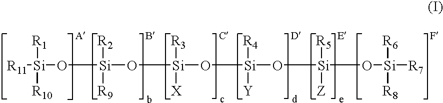

wherein R₁₋₁₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein X comprises an ultraviolet absorbing moiety or R₁₂; wherein Y comprises a polyether; wherein Z comprises at least one of hydrogen, R₁₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; and wherein the ratio of b:c:d:e is such that the resulting compound exhibits surfactant characteristics in water and forms a stable emulsion in the same.

### CROSS-REFERENCE TO RELATED APPLICATIONS

This application claims the benefit of U.S. Provisional Application Serial No. 60/324,570 filed Sep. 25, 2001, U.S. Provisional Application Serial No. 60/344,659 filed Dec. 24, 2001, U.S. Provisional Application Serial No. 60/351,952 filed Jan. 25, 2002, and U.S. Provisional Application Serial No. 60/387,618 filed Jun. 11, 2002, all of which are hereby incorporated herein by reference in their entirety.

### BACKGROUND OF THE INVENTION

1. Field of the Invention

The present invention relates in general to silicone based compounds, and, more particularly, to silicone based ultraviolet absorbing and/or scattering compounds which can be incorporated into numerous formulations for use as cancer mitigating agents, cancer precluding agents, and/or sun-blocking agents for humans and/or other tangible objects, including those in the automotive and marine industries—just to name a few.

2. Background Art

Ultraviolet absorbing materials, such as cinnamate esters, have been known in the art for several years. Ultraviolet scattering materials, such as titanium dioxide, have likewise been known in the art for several years. While the utilization of both ultraviolet absorbing and scattering materials has been identified in, among other things, sunscreen formulations, cosmetic formulations, several issues relative to formulation complexity, toxicity, and/or expense remain problematic, or at least less than optimum, for commercial applications—especially where the particular formulation is topically associated with a human.

It is therefore an object of the present invention to provide novel silicone based compounds for use in associated formulations which remedy the aforementioned detriments and/or complications associated with conventional ultraviolet absorbing and scattering materials and their associated commercial formulations.

### SUMMARY OF THE INVENTION

The present invention is directed to a compound represented by the following structural formula:

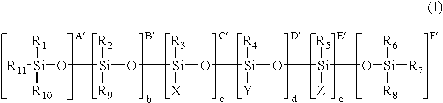

wherein R₁₋₁₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein X comprises an ultraviolet absorbing moiety or R₁₂; wherein Y comprises a polyether; wherein Z comprises at least one of hydrogen, R₁₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; and wherein the ratio of b:c:d:e is such that the resulting compound exhibits surfactant characteristics in water and forms a stable emulsion in the same.

The present invention is further directed to a compound represented by the following structural formula:

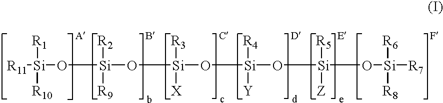

wherein R₁₋₁₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein X comprises an ultraviolet absorbing moiety or R₁₂; wherein Y comprises a polyether; wherein Z comprises at least one of hydrogen, R₁₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 1-10,000; wherein c is an integer ranging from approximately (1-10,000)−x, wherein x≦c; wherein d is an integer ranging from approximately (1-10,000)−y, wherein y≦d; and wherein e is an integer approximately equal to x+y.

In a preferred embodiment of the present invention, b is an integer ranging from approximately 2-50; c is an integer ranging from approximately (1-50)−x; d is an integer ranging from approximately (1-50)−y; and e is an integer approximately equal to x+y.

In another preferred embodiment of the present invention, b is an integer ranging from approximately 10-25; c is an integer ranging from approximately (1-10)−x; d is an integer ranging from approximately (1-10)−y; and e is an integer approximately equal to x+y. In this embodiment X may comprise a cinnamate ester.

In yet another preferred embodiment of the present invention, b is an integer ranging from approximately 10-20; c is an integer ranging from approximately (1-10)−x; d is an integer ranging from approximately (1-10)−y; and e is an integer approximately equal to x+y. In this embodiment X may comprise a cinnamate ester.

The present invention is also directed to a compound represented by the following structural formula:

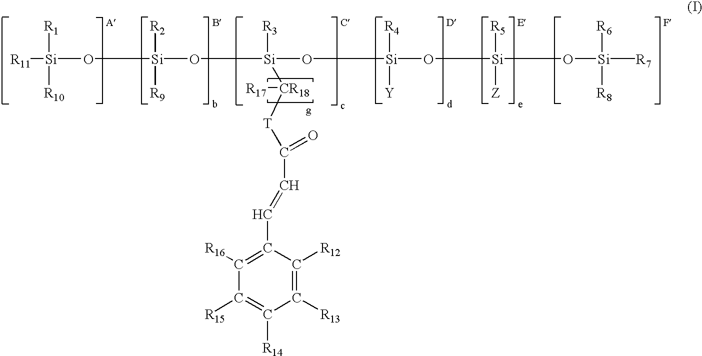

wherein R₁₋₂₀ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein T comprises O or NR₁₉; wherein Y comprises a polyether; wherein Z comprises at least one of hydrogen, R₂₀, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 1-50; wherein c is an integer ranging from approximately (1-50)−x, wherein x≦c; wherein d is an integer ranging from approximately (1-50)−y, wherein y≦d; wherein e is an integer approximately equal to x+y; and wherein g is an integer ranging from approximately 1-10.

In a preferred embodiment of the present invention, b is an integer ranging from approximately 2-50; c is an integer ranging from approximately (1-50)−x; d is an integer ranging from approximately (1-50)−y; and e is an integer approximately equal to x+y.

In accordance with the present invention, b is an integer ranging from approximately 10-25; c is an integer ranging from approximately (1-10)−x; d is an integer ranging from approximately (1-10)−y; and e is an integer approximately equal to x+y.

In yet another preferred embodiment of the present invention, b is an integer ranging from approximately 10-20; c is an integer ranging from approximately (1-10)−x; d is an integer ranging from approximately (1-10)−y; and e is an integer approximately equal to x+y.

The present invention additionally discloses a compound represented by the following structural formula:

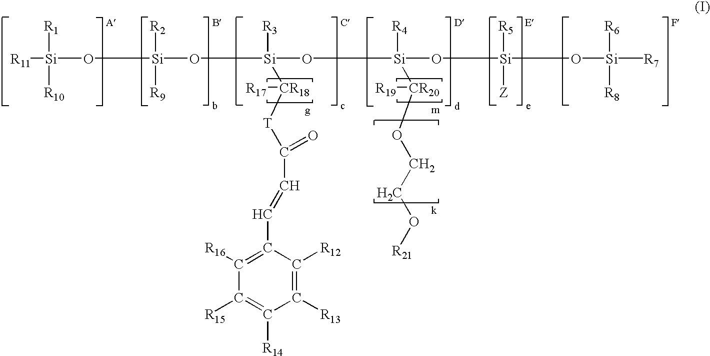

wherein R₁₋₂₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein T comprises O or NR₂₂; wherein Z comprises at least one of hydrogen, R₂₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 1-50; wherein c is an integer ranging from approximately (1-50)−x, wherein x≦c; wherein d is an integer ranging from approximately (1-50)−y, wherein y≦d; wherein e is an integer approximately equal to x+y; wherein g is an integer ranging from approximately 1-10; wherein k is an integer ranging from approximately 1-50; and wherein m is an integer ranging from approximately 1-5.

In a preferred embodiment of the present invention, b is an integer ranging from approximately 2-50; c is an integer ranging from approximately (1-50)−x; d is an integer ranging from approximately (1-50)−y; and e is an integer approximately equal to x+y.

In another preferred embodiment of the present invention, b is an integer ranging from approximately 10-25; c is an integer ranging from approximately (1-10)−x; d is an integer ranging from approximately (1-10)−y; and e is an integer approximately equal to x+y.

In yet another preferred embodiment of the present invention, b is an integer ranging from approximately 10-20; c is an integer ranging from approximately (1-10)−x; d is an integer ranging from approximately (1-10)−y; and e is an integer approximately equal to x+y.

The present invention is further directed to a compound represented by the following structural formula:

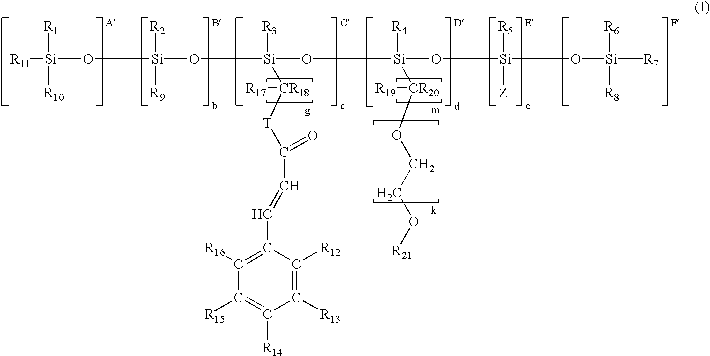

wherein R₁₋₂₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein T comprises O or NR₂₂; wherein Z comprises at least one of hydrogen, R₂₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 10-20; wherein c is an integer ranging from approximately (1-10)−x, wherein x≦c; wherein d is an integer ranging from approximately (1-10)−y, wherein y≦d; wherein e is an integer approximately equal to x+y; wherein g is an integer ranging from approximately 1-10; wherein k is an integer ranging from approximately 2-20; and wherein m is an integer ranging from approximately 1-5.

The present invention also discloses a compound represented by the structural formula comprising:

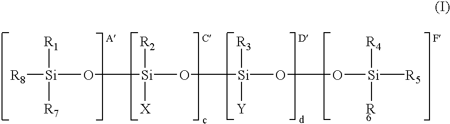

wherein R₁₋₈ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein X comprises an ultraviolet absorbing moiety; wherein Y comprises a polyether; wherein A′ and F′ are terminal moieties; wherein C′ and D′ are non-terminal moieties independently positioned between A′ and F′ in any order; wherein c is an integer ranging from approximately 1-10,000; and wherein d is an integer ranging from approximately 1-10,000.

These and other objectives of the present invention will become apparent in light of the present specification and claims.

### DETAILED DESCRIPTION OF THE INVENTION

While this invention is susceptible of embodiment in many different forms, there is described herein in detail several specific embodiments with the understanding that the present disclosure is to be considered as an exemplification of the principles of the invention and is not intended to limit the invention to the embodiments illustrated.

Formulations having as a component part a silicone based compound as disclosed herein can be used in a wide variety of applications, wherein the absorption and/or scattering of ultraviolet radiation is desirable. Such applications include: single-ingredient aqueous sunscreens; ultraviolet protective additives for aqueous based hair and cosmetic formulations; aqueous based ultraviolet protection for cloth, vinyl, leather, interior and exterior plastic components for both the vehicular and marine industries; interior and exterior paint for a multitude of applications; spray applications for automated car washes; spray applications from a bottle for a multitude of different uses; and additives to wax formulations for cars, boats, etcetera.

In a first embodiment of the present invention, the silicone based compound may be represented by the following structural formula:

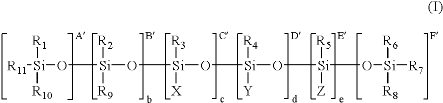

wherein R₁₋₁₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein X comprises an ultraviolet absorbing moiety or R₁₂; wherein Y comprises a polyether; wherein Z comprises at least one of hydrogen, R₁₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; and wherein the ratio of b:c:d:e is such that the resulting compound exhibits surfactant characteristics in water and forms a stable emulsion in the same.

In a second embodiment of the present invention, the silicone based compound may be represented by the following structural formula:

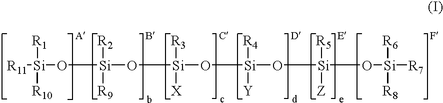

wherein R₁₋₁₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein X comprises an ultraviolet absorbing moiety or R₁₂; wherein Y comprises a polyether; wherein Z comprises at least one of hydrogen, R₁₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 1-10,000; wherein c is an integer ranging from approximately (1-10,000)−x, wherein x≦c; wherein d is an integer ranging from approximately (1-10,000)−y, wherein y≦d; and wherein e is an integer approximately equal to x+y. Preferably, b is an integer ranging from approximately 2-50; c is an integer ranging from approximately (1-50)−x; d is an integer ranging from approximately (1-50)−y; and e is an integer approximately equal to x+y. More preferably, b is an integer ranging from approximately 10-25; c is an integer ranging from approximately (1-10)−x; d is an integer ranging from approximately (1-10)−y; and e is an integer approximately equal to x+y. Yet more preferably, b is an integer ranging from approximately 10-20; c is an integer ranging from approximately (1-10)−x; d is an integer ranging from approximately (1-10)−y; and e is an integer approximately equal to x+y.

In a third embodiment of the present invention, the silicone based compound may be represented by the following structural formula:

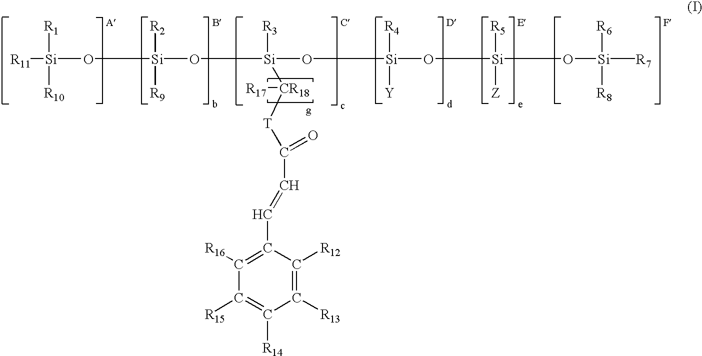

wherein R₁₋₂₀ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein T comprises O or NR₁₉; wherein Y comprises a polyether; wherein Z comprises at least one of hydrogen, R₂₀, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 1-50; wherein c is an integer ranging from approximately (1-50)−x, wherein x≦c; wherein d is an integer ranging from approximately (1-50)−y, wherein y≦d; wherein e is an integer approximately equal to x+y; and wherein g is an integer ranging from approximately 1-10. Preferably, b is an integer ranging from approximately 2-50; c is an integer ranging from approximately (1-50)−x; d is an integer ranging from approximately (1-50)−y; and e is an integer approximately equal to x+y. More preferably, b is an integer ranging from approximately 10-25; c is an integer ranging from approximately (1-10)−x; d is an integer ranging from approximately (1-10)−y; and e is an integer approximately equal to x+y. Yet more preferably, b is an integer ranging from approximately 10-20; c is an integer ranging from approximately (1-10)−x; d is an integer ranging from approximately (1-10)−y; and C is an integer approximately equal to x+y.

In a fourth embodiment of the present invention, the silicone based compound is represented by the following structural formula:

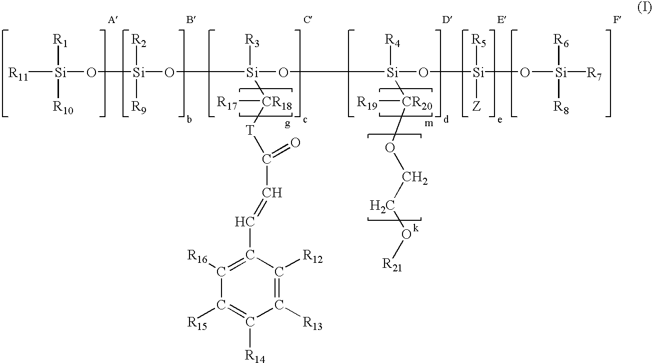

wherein R₁₋₂₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein T comprises O or NR₂₂; wherein Z comprises at least one of hydrogen, R₂₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 1-50; wherein c is an integer ranging from approximately (1-50)−x, wherein x≦c; wherein d is an integer ranging from approximately (1-50)−y, wherein y≦d; wherein e is an integer approximately equal to x+y; wherein g is an integer ranging from approximately 1-10; wherein k is an integer ranging from approximately 1-50; and wherein m is an integer ranging from approximately 1-5. Preferably, b is an integer ranging from approximately 2-50; c is an integer ranging from approximately (1-50)−x; d is an integer ranging from approximately (1-50)−y; and e is an integer approximately equal to x+y. More preferably, b is an integer ranging from approximately 10-25; c is an integer ranging from approximately (1-10)−x; d is an integer ranging from approximately (1-10)−y; and e is an integer approximately equal to x+y. Yet more preferably, b is an integer ranging from approximately 10-20; c is an integer ranging from approximately (1-10)−x; d is an integer ranging from approximately (1-10)−y; and e is an integer approximately equal to x+y.

In a fifth embodiment of the present invention, the silicone based compound is represented by the following structural formula:

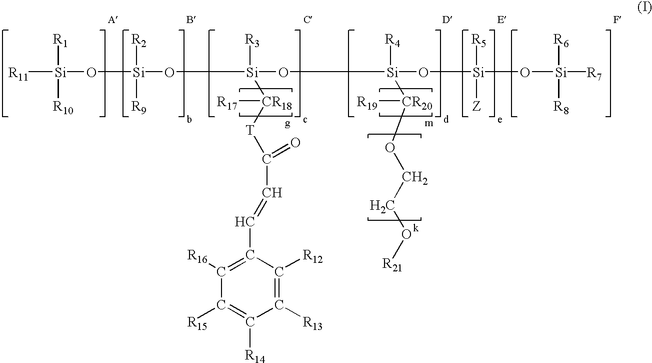

wherein R₁₋₂₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein T comprises O or NR₂₂; wherein Z comprises at least one of hydrogen, R₂₃, a hydroxyl group, an oxygen atom hydrolysis cross-linked to the same compound represented by formula (I) or another compound represented by formula (I), and a polyether cross-linked to the same compound represented by formula (I) or another compound represented by formula (I); wherein A′ and F′ are terminal moieties; wherein B′, C′, D′, and E′ are non-terminal moieties independently positioned between A′ and F′ in any order; wherein b is an integer ranging from approximately 10-20; wherein c is an integer ranging from approximately (1-10)−x, wherein x≦c; wherein d is an integer ranging from approximately (1-10)−y, wherein y≦d; wherein e is an integer approximately equal to x+y; wherein g is an integer ranging from approximately 1-10; wherein k is an integer ranging from approximately 2-20; and wherein m is an integer ranging from approximately 1-5.

In a sixth embodiment of the present invention, the silicone based compound is represented by the structural formula comprising:

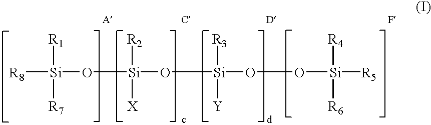

wherein R₁₋₈ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof; wherein X comprises an ultraviolet absorbing moiety; wherein Y comprises a polyether; wherein A′ and F′ are terminal moieties; wherein C′ and D′ are non-terminal moieties independently positioned between A′ and F′ in any order; wherein c is an integer ranging from approximately 1-10,000; and wherein d is an integer ranging from approximately 1-10,000.

In order to further illustrate the present invention and the advantages thereof, the following specific examples are provided with the understanding that the same are intended to be illustrative and, in no way, limitative.

It will be further understood that conventional chemical abbreviations will be used when appropriate including the following: grams (g); milliliters (mL); moles (mol); millimoles (mmol); molar (M); millimolar (mM); pounds per square inch (psi); hours (h); degrees Centigrade (°C.); and parts per million (ppm).

### EXAMPLE 1

### Preparation of SBC 1 (a/k/a Aqua Shield 18-5-4)

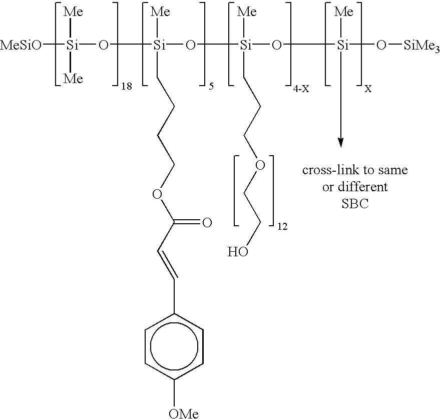

A 500 mL three-neck round bottom flask fitted with a magnetic stir bar, gas inlet adapter, and stoppers was charged with the product from 2,4,6,8-tetramethylcyclotetrasiloxane, octomethylcyclotetrasiloxane, and hexamethyldisiloxane with an acid clay to make Si—H functional silicone which was purified via filtration prior to use (Aldrich Chemical) (40.91 g, 26.07 mmol, previously stripped of cyclic and small linear siloxanes via distillation to >150° C. at 0.01 torr), 3-butenyl-para-methoxycinnamate (prepared via conventional organic method using acid chloride and alcohol precursors from Aldrich Chemical) (25.64 g, 110.38 mmol), and allyl/OH-terminal-EO12-polyethyleneoxide (600 MW allyl/alcohol terminal PEO from Dow Corning) (52.11 g, 88.82 mmol). The polyethylene oxide had been previously dried via azeotropic distillation from toluene. Dissolved air was purged from the reaction mixture and replaced with nitrogen via four successive evacuations and nitrogen back-fills while stirring at room temperature, whereupon the reaction mixture was maintained under a positive pressure of nitrogen. The magnetic stir bar was removed and replaced with a mechanical stirrer (Teflon paddle hooked to a glass rod connected to an overhead motor via a greased Ace Inc. Truebore seal). The contents were heated to 85° C. and vigorously stirred to give an opaque mixture, whereupon 60.7 mL of catalyst solution (freshly prepared 0.05 M H₂PtCl₆.6H₂O in isopropyl alcohol) was added via syringe under positive nitrogen flow to yield a Pt concentration of 5 ppm. The reaction mixture became clear in approximately 4 hours. Heating was discontinued at 4 hours 40 minutes whereupon air was bubbled into the reaction mixture with continued stirring for 20 minutes. 9.76 g of product, a clear, colorless, viscous liquid, was removed. 610 mL of water was added to the remaining product with continued mechanical stirring to produce a white emulsion that was 85% by mass water. The emulsion was stirred for 30 minutes, whereupon it was transferred to a separatory funnel and extracted three times, each time with 800 mL of hexane. Remaining hexane was removed from the emulsion via a trap to liquid-nitrogen-cooled-trap distillation while warming the emulsion to 45° C. Any water removed during this process was restored to the emulsion.

### Optional Step to Remove Any Si—H

10.00 g of the above-prepared product was isolated from a previous hydrosilation reaction. It was a cloudy, viscous liquid that contained 5 ppm Pt from the catalyst used during the hydrosilation. IR spectroscopy revealed that this product contained residual Si—H functionality. The 10.00 g of product was combined with 25 mL of methanol and refluxed under nitrogen for 9 hours, whereupon all volatiles up to a boiling point of 130° C. were stripped via distillation in vacuo (0.01 torr). The resulting product was completely clear and IR spectroscopy revealed no detectable Si—H. The product, upon mixing with water, formed suitable emulsions.

### EXAMPLE 2

### Preparation of SBC 2 (a/k/a Cinnamate Free Aqua Shield 18-5-4)

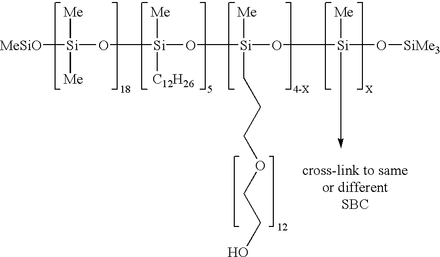

A 500 mL three-neck round bottom flask fitted with a magnetic stir bar, gas inlet adapter, and stoppers was charged with the product from 2,4,6,8-tetramethylcyclotetrasiloxane, octomethylcyclotetrasiloxane, and hexamethyldisiloxane with an acid clay to make Si—H functional silicone which was purified via filtration prior to use (Aldrich Chemical) (50.0 g, 24.53 mmol, previously stripped of cyclic and small linear siloxanes via distillation to >150° C. at 0.01 torr), 1-dodecene (Aldrich Chemical) (22.71 g, 134.92 mmol), and allyl/OH-terminal-EO12-polyethyleneoxide (600 MW allyl/alcohol terminal PEO from Dow Coming) (63.35 g, 107.97 mmol). The polyethylene oxide had been previously dried via azeotropic distillation from toluene. Dissolved air was purged from the reaction mixture and replaced with nitrogen via four successive evacuations and nitrogen back-fills while stirring at room temperature, whereupon the reaction mixture was maintained under a positive pressure of nitrogen. The magnetic stir bar was removed and replaced with a mechanical stirrer (Teflon paddle hooked to a glass rod connected to an overhead motor via a greased Ace Inc. Truebore seal). The contents were heated to 85° C. and vigorously stirred to give an opaque mixture, whereupon 70.0 mL of catalyst solution (freshly prepared 0.05 M H₂PtCl₆.6H₂O in isopropyl alcohol) was added via syringe under positive nitrogen flow to yield a Pt concentration of 5 ppm. The reaction mixture was stirred for 11 hours at which time it was a cloudy, colorless, semi-viscous liquid. Heating was discontinued and air was bubbled into the reaction mixture with continued stirring for 30 minutes. 98.1 g of product comprising, a cloudy, colorless, viscous liquid, was removed. 210 mL of water was added to the remaining product with continued mechanical stirring for 1 hour to produce a white emulsion that was 85% by mass water.

It will be understood that both of the above-identified examples yielded products resulting in compounds which exhibit surfactant characteristics in water and form a stable emulsions in the same.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A compound represented by the following structural formula: 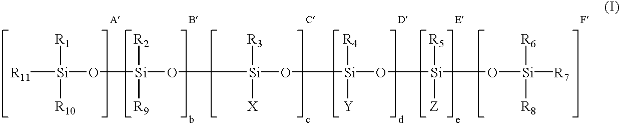
wherein R₁₋₁₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof;
wherein X comprises an ultraviolet absorbing moiety or R₁₂;
wherein Y comprises a polyether;
wherein Z comprises at least one of hydrogen, R₁₃, a hydroxyl group, an oxygen atom hydrolysis cross-linked to the same compound represented by formula (I) or another compound represented by formula (I), and a polyether cross-linked to the same compound represented by formula (I) or another compound represented by formula (I);
wherein A′ and F′ are terminal moieties;
wherein B′, C′, D′, and E′ are non-terminal moieties independently positioned between A′ and F′ in any order; and
wherein the ratio of b:c:d:e is such that the resulting compound exhibits surfactant characteristics in water and forms a stable emulsion in the same.

2. A compound represented by the following structural formula: 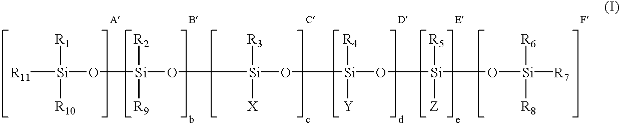
wherein R₁₋₁₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof;
wherein X comprises an ultraviolet absorbing moiety or R₁₂;
wherein Y comprises a polyether;
wherein Z comprises at least one of hydrogen, R₁₃, a hydroxyl group, an oxygen atom hydrolysis cross-linked to the same compound represented by formula (I) or another compound represented by formula (I), and a polyether cross-linked to the same compound represented by formula (I) or another compound represented by formula (I);
wherein A′ and F′ are terminal moieties;
wherein B′, C′, D′, and E′ are non-terminal moieties independently positioned between A′ and F′ in any order;
wherein b is an integer ranging from approximately 1-10,000;
wherein c is an integer ranging from approximately (1-10,000)−x, wherein x C;
wherein d is an integer ranging from approximately (1-10,000)−y, wherein y≦d; and
wherein e is an integer approximately equal to x+y.

3. The compound according to claim 2, wherein b is an integer ranging from approximately 2-50; wherein c is an integer ranging from approximately (1-50)−x; wherein d is an integer ranging from approximately (1-50)−y; and wherein e is an integer approximately equal to x+y.

4. The compound according to claim 3, wherein X comprises a cinnamate ester.

5. The compound according to claim 2, wherein b is an integer ranging from approximately 10-25; wherein c is an integer ranging from approximately (1-10)−x; wherein d is an integer ranging from approximately (1-10)−y; and wherein e is an integer approximately equal to x+y.

6. The compound according to claim 5, wherein X comprises a cinnamate ester.

7. The compound according to claim 2, wherein b is an integer ranging from approximately 10-20; wherein c is an integer ranging from approximately (1-10)−x; wherein d is an integer ranging from approximately (1-10)−y; and wherein e is an integer approximately equal to x+y.

8. The compound according to claim 7, wherein X comprises a cinnamate ester.

9. A compound represented by the following structural formula: 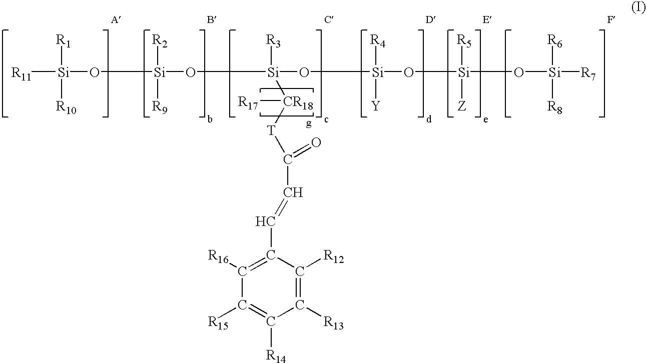
wherein R₁₋₂₀ are the same or different and comprise H. a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof;
wherein T comprises O or NR₉;
wherein Y comprises a polyether;
wherein Z comprises at least one of hydrogen, R₂₀, a hydroxyl group, an oxygen atom hydrolysis cross-linked to the same compound represented by formula (I) or another compound represented by formula (I), and a polyether cross-linked to the same compound represented by formula (I) or another compound represented by formula (I);
wherein A′ and F′ are terminal moieties;
wherein B′, C′, D′, and E′ are non-terminal moieties independently positioned between A′ and F′ in any order;
wherein b is an integer ranging from approximately 1-50;
wherein c is an integer ranging from approximately (1-50)−x, wherein x≦c;
wherein d is an integer ranging from approximately (1-50)−y, wherein y≦d;
wherein e is an integer approximately equal to x+y; and
wherein g is an integer ranging from approximately 1-10.

10. The compound according to claim 9, wherein b is an integer ranging from approximately 2-50; wherein c is an integer ranging from approximately (1-50)−x; wherein d is an integer ranging from approximately (1-50)−y; and wherein e is an integer approximately equal to x+y.

11. The compound according to claim 9, wherein b is an integer ranging from approximately 10-25; wherein c is an integer ranging from approximately (1-10)−x; wherein d is an integer ranging from approximately (1-10)−y; and wherein e is an integer approximately equal to x+y.

12. The compound according to claim 9, wherein b is an integer ranging from approximately 10-20; wherein c is an integer ranging from approximately (1-10)−x; wherein d is an integer ranging from approximately (1-10)−y; and wherein e is an integer approximately equal to x+y.

13. A compound represented by the following structural formula: 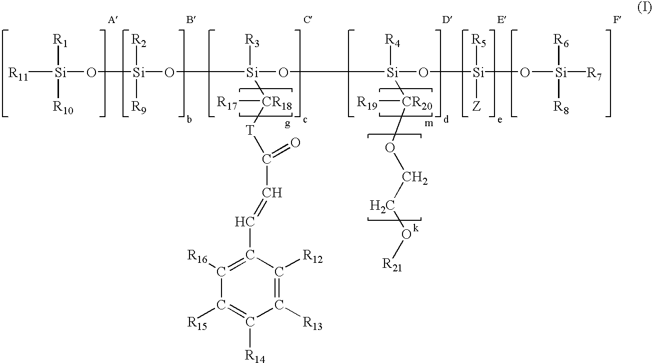
wherein R₁₋₂₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof;
wherein T comprises O or NR₂₂;
wherein Z comprises at least one of hydrogen, R₂₃, a hydroxyl group, an oxygen atom hydrolysis cross-linked to the same compound represented by formula (I) or another compound represented by formula (I), and a polyether cross-linked to the same compound represented by formula (I) or another compound represented by formula (I);
wherein A′ and F′ are terminal moieties;
wherein B′, C′, D′, and E′ are non-terminal moieties independently positioned between A′ and F′ in any order;
wherein b is an integer ranging from approximately 1-50;
wherein c is an integer ranging from approximately (1-50)−x, wherein x≦c;
wherein d is an integer ranging from approximately (1-50)−y, wherein y≦d;
wherein e is an integer approximately equal to x+y;
wherein g is an integer ranging from approximately 1-10;
wherein k is an integer ranging from approximately 1-50; and
wherein m is an integer ranging from approximately 1-5.

14. The compound according to claim 13, wherein b is an integer ranging from approximately 2-50; wherein c is an integer ranging from approximately (1-50)−x; wherein d is an integer ranging from approximately (1-50)−y; and wherein e is an integer approximately equal to x+y.

15. The compound according to claim 13, wherein b is an integer ranging from approximately 10-25; wherein c is an integer ranging from approximately (1-10)−x; wherein d is an integer ranging from approximately (1-10)−y; and wherein e is an integer approximately equal to x+y.

16. The compound according to claim 13, wherein b is an integer ranging from approximately 10-20; wherein c is an integer ranging from approximately (1-10)−x; wherein d is an integer ranging from approximately (1-10)−y; and wherein e is an integer approximately equal to x+y.

17. A compound represented by the following structural formula: 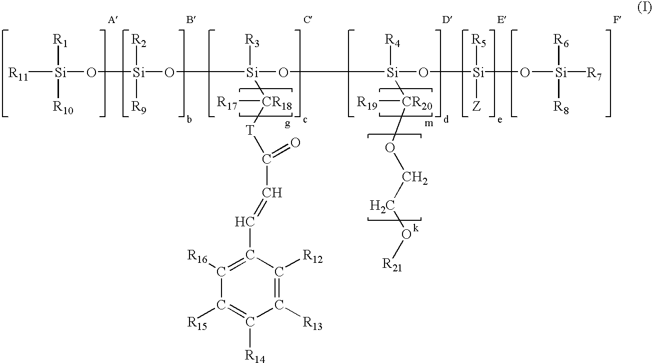
wherein R₁₋₂₃ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof;
wherein T comprises O or NR₂₂;
wherein Z comprises at least one of hydrogen, R₂₃, a hydroxyl group, an oxygen atom hydrolysis cross-linked to the same compound represented by formula (I) or another compound represented by formula (I), and a polyether cross-linked to the same compound represented by formula (I) or another compound represented by formula (I);
wherein A′ and F′ are terminal moieties;
wherein B′, C′, D′, and E′ are non-terminal moieties independently positioned between A′ and F′ in any order;
wherein b is an integer ranging from approximately 10-20;
wherein c is an integer ranging from approximately (1-10)−x, wherein x≦c;
wherein d is an integer ranging from approximately (1-10)−y, wherein y≦d;
wherein e is an integer approximately equal to x+y;
wherein g is an integer ranging from approximately 1-10;
wherein k is an integer ranging from approximately 2-20; and
wherein m is an integer ranging from approximately 1-5.

18. A compound represented by the structural formula comprising: 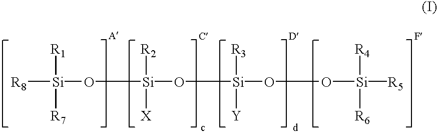
wherein R₁₋₈ are the same or different and comprise H, a hydroxyl group, a straight or branched alkyl, cycloalkyl, polycycloalkyl, heterocycloalkyl, alkaryl, alkoxy, aryl, aralkyl, alkenyl, or alkynyl group containing approximately 1 to approximately 50 carbon atom(s) and combinations thereof;
wherein X comprises an ultraviolet absorbing moiety;
wherein Y comprises a polyether;
wherein A′ and F′ are terminal moieties;
wherein C′ and D′ are non-terminal moieties independently positioned between A′ and F′ in any order;
wherein c is an integer ranging from approximately 1-10,000; and
wherein d is an integer ranging from approximately 1-10,000.
